(19) United States
(12) Patent Application Publication
(10) Pub. No.: US 2002/0055083 A1
(43) Pub. Date: May 9, 2002

(54) Filler member for a dental impression tray

(76) Inventor: Deanna Gionet, Lucasville (CA)

Correspondence Address: JACK PAAVILA, BOX 1151, ALEXANDRIA, KOC IA0, CA

(21) Appl. No.: 09/900,155

(22) Filed: Jul. 9, 2001

Related U.S. Application Data
(60) Provisional application No. 60/246,691, filed on Nov. 9, 2000.

(51) Int. Cl. A61C 19/00; A61C 9/00

(52) U.S. Cl. 433/34; 433/37

(57) ABSTRACT

A filler member for use in molding a dental model in a dental impression formed in a mold carried in a mandibular dental impression tray. The tray has a u-shaped trough formed by inner and outer u-shaped walls joined by a bottom wall. The inner wall defines a lingual space. The filler member is made from shape-retaining material with a smooth surface and is shaped to fill at least the upper portion of the lingual space in the impression tray when placed therein. The filler member is placed in the lingual space in a manner to prevent model forming material, used in molding the model, from entering the lingual space on the tray from the upper portion of the tray.

### RELATED APPLICATIONS

This application claims the benefit of U.S. provisional application Ser. No. 60/246,691, filed Nov. 9, 2000.

### BACKGROUND OF THE INVENTION

1. Field of the Invention

This invention is directed toward a filler member for use with a mandibular dental impression tray.

2. Description of the Related Art Including Information Disclosed Under CFR §§ 1.97-1.99

Dental impressions are used in the dental profession to obtain accurate three dimensional reproductions or models of a person's teeth and the mouth area adjacent the teeth. The models help the dental team to diagnose cases; determine treatment plans; fabricate appliances and prosthetic devices; and to determine any change in a person's dentition over a period of time.

A dental impression is obtained by filling a dental impression tray with a mold forming material and then placing the tray in the patient's mouth with the person's teeth set in the mold forming material in the tray. Once the mold forming material sets, the tray, carrying the set material, is removed from the mouth to provide a mold of the teeth and the surrounding tissue.

The mold, still carried by the tray, is then filled with a model forming material. The filled mold is then inverted and set on a base. The base is also usually made of model forming material. Once the model forming material in the mold sets, it forms a model of the person's teeth, the model of the teeth securely mounted on the base. The tray and the mold are then removed from the model. The mounted model is kept as a record of the patient's teeth.

Mandibular dental impression trays, used for taking an impression of the lower teeth, are u-shaped to accommodate the tongue in the open lingual space between the arms of the tray when the tray is placed in the mouth. This open lingual space however receives overflow model forming material when molding the model. This overflow material makes the finished model look messy. It further hinders visual and handling access to the inner or lingual side of the model which makes the fabrication of various dental appliances difficult. The overflow material can also make separation of the model from the mold more difficult.

To avoid the problems associated with model forming material overflow, some dental professionals fill the lingual space before molding the model. Some use dry, wadded, tissue or paper to fill the space. However the dry paper material will absorb liquid from the model molding material which could affect the strength of the model being formed. Also the dry wadded paper material produces a rough surface on the model and also ends up partly embedded in the model providing a poor appearance. Wet, wadded, tissue or paper is also sometimes employed to fill the lingual space. However, the water in the wet paper material can affect the water content in the model forming material again affecting the strength of the model. It is also known to make a filler from mold forming material but this method takes extra time to prepare and place the filler and to allow it to set. Also, the additional tools used in preparing the additional filler material must be cleaned which is time consuming.

### SUMMARY OF THE INVENTION

It is the purpose of the present invention to provide a filler member which helps to more quickly produce a neat and clean dental model by preventing overflow model forming material from entering the lingual space in a mandibular dental impression tray. In accordance with the present invention a filler member is provided which is shaped to fill at least a portion of the lingual space in the impression tray in a manner to prevent entry of model forming material into the space. The filler member can be quickly and easily placed in the lingual space of the tray once the mold is produced in the tray and before the model forming material is poured into the mold. The filler member prevents the model forming material from entering the lingual space. The filler member has connecting means for detachably connecting it to the tray adjacent the lingual space to retain it in position and also preferably has handling means for easily handling it.

The invention is particularly directed toward a shape-retaining, filler member for use in molding a dental model in a mold carried in a mandibular dental impression tray. The tray has a u-shaped trough formed by inner and outer u-shaped walls joined by a bottom wall and the inner wall defines a lingual space. The filler member is smooth surfaced and shaped to fill at least a portion of the lingual space in the tray in a manner to prevent model forming material used in molding the model from entering the lingual space.

### BRIEF DESCRIPTION OF THE DRAWINGS

FIG. 1 is perspective view of one embodiment of the filler member;

FIG. 2 is a cross-section view taken along line 2-2 in FIG. 1;

FIG. 3 is a perspective view of an empty mandibular dental impression tray;

FIG. 4 is a cross-section view of the tray, taken along line 4-4 in FIG. 3, being filled with a mold forming molding material;

FIG. 5 is the cross-section view of the tray with the mold formed therein and with the filler member in place;

FIG. 6 is the cross section view of the tray with the mold, in the tray, filled with model forming material;

FIG. 7 is a cross-section view showing the finished model mounted on a base;

FIG. 8 is a cross-section view, similar to FIG. 5, of another embodiment of the filler member;

FIG. 9 is a cross-section view, similar to FIG. 5 of another embodiment of the filler member;

FIG. 10 is a cross-section view, similar to FIG. 2, of another embodiment of the filler member;

FIG. 11 is a cross-section view, similar to FIG. 5, showing the filler member of FIG. 10 mounted in the tray; and

FIG. 12 is a detail cross-section view showing another form of connecting means for connecting the filler member to the tray.

### DESCRIPTION OF THE PREFERRED EMBODIMENTS

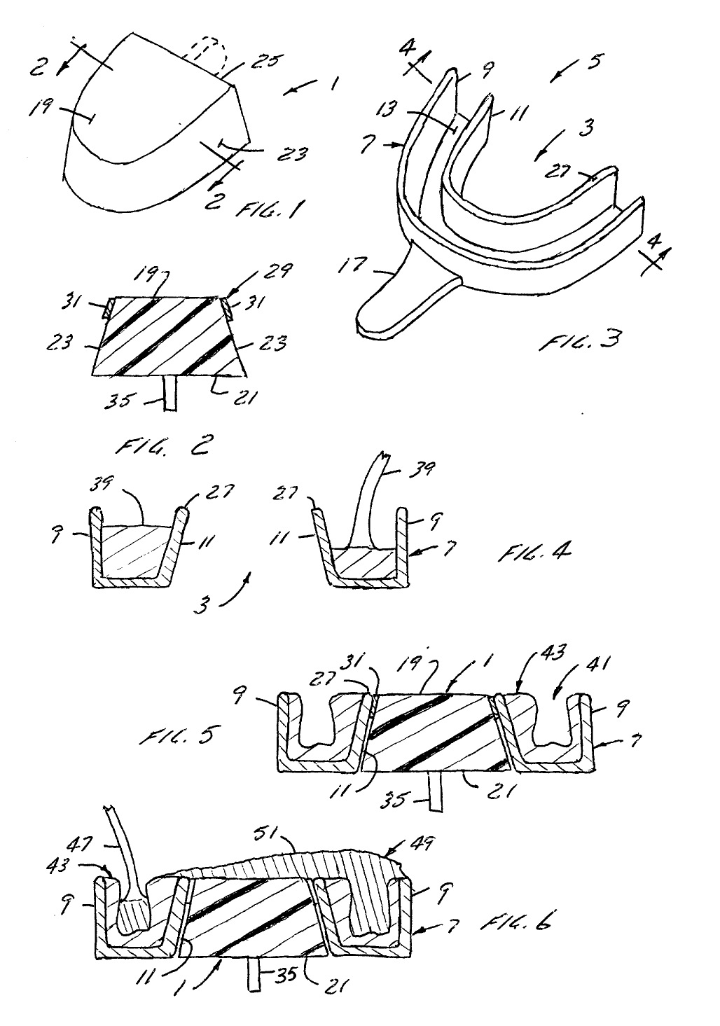

The filler member 1, as shown in FIGS. 1 and 2, is shaped to fit into the lingual space 3 on a mandibular dental impression tray 5. The tray 5 itself, shown in FIG. 3, has a u-shaped trough 7 defined by outer and inner u-shaped walls 9, 11 joined by a bottom wall 13. The inner wall 11 defines the open lingual space 3 on the tray. The trough 7 is sized to loosely enclose the lower set of teeth in a patient's mouth. A handling tab 17, attached to the front of the bottom wall 13, extends forwardly from the trough 7.

The filler member 1 is made from shape-retaining, inexpensive material such as plastic. It could however be also made from other materials, or mixtures of materials, with like properties. The member can be made from any material which does not react with, or adversely affect or be affected by, the mold or model forming materials. the member is also made from materials which easily separate from the mold and model forming materials and which provides a smooth surface.

The member 1 is tongue shaped to fit snugly within the lingual space 3 substantially filling the space. The member 1 has generally parallel top and bottom surfaces 19, 21 joined by a curved side surface 23 and a straight back surface 25. The curved side surface 23 also preferably slants toward the top surface 19 from the bottom surface 21 following the slope of the inner wall 11 of the tray 5. The member 1 has a thickness generally equal to the height of the inner wall 11. This height is around 1.70 cm. but can vary depending on the size of the tray. When the member 1 is placed within the space 3 its top surface 19 is generally level with the top edge 27 of the inner wall 11.

The filler member 1 has connecting means 29 for use in connecting the member to the dental tray 5 while in the lingual space 3. The connecting means 29 can comprise a double-sided adhesive tape 31. The tape 31 can be provided with a protective release layer (not shown) on each side, such a construction being well known. One release layer is removed allowing the tape to be placed on the side surface 23 of the filler member. The tape 31 is shown located adjacent the top surface 19 of the member but it can be located at any position of the side surface 23 or can even cover it completely. The second release layer on the adhesive tape 31 is removed when the member 1 is to be used. The adhesive tape 31 adheres the member 1 onto the inner side wall 11 of the tray 5 when the member 1 is positioned within the lingual space 3 as will be described. While the adhesive has been shown applied as a tape 31 it can be applied in other forms, such as in patches or dots, on the side surface 23 of the member. The adhesive employed is strong enough to maintain the filler member in position, yet allows the filler member to be removed when not needed.

The protective member 1 can also be provided with handling means. The handling means can include an integral tab 35 projecting up from the center of the top surface 19 of the member, the tab 35 large enough to be readily grasped by the user's fingers to place or remove the member on or from the impression tray. The sides of the tab 35 preferably are roughened. While the tab 35 has been shown as projecting up from the top surface, it could also extend laterally from the back surface 25 of the member as shown in dotted lines in FIG. 1.

In use, the u-shaped impression tray 5, shown in FIG. 3, has the trough 7 filled with mold forming material 39 as shown in FIG. 4. The mold forming material is usually alginate although other similar materials, known in the profession, can be used. The filled tray is then placed inside a patient's mouth to encompass the bottom set of the patient's teeth with the mold forming material carried by the tray. After the mold forming material sets, the tray 5 is removed from the mouth, carrying an impression 41 of the teeth in the set material. The set material forms a mold 43. Any mold forming material that overflows from the trough 7 into the lingual space 3 of the tray is removed and the portion of the tray defining the lingual space 3 is cleaned and dried.

The filler member 1 is now placed within the lingual space 3 with its top flat surface 19 level with the top edge 27 of the inner wall 11, and adhered to the inner wall with the adhesive tape 31 as shown in FIG. 5. The filler member is inserted upwardly into the lingual space 3 from the bottom of the space. Model forming material 47 is now mixed and poured into the impression 41 in the mold 43, the mold still carried by the tray 5. The material 47 fills the mold 43, as shown in FIG. 6, to form the model 49 and overflows the mold to cover the top surface 19 of the filler member 1 and to form a bottom 51 for the model 49. The model forming material is usually a flowable mix of gypsum powder and water, although any other suitable model forming materials, known in the profession, can be used. The assembly of the mold 43 and the tray 5 is usually vibrated as the model forming material is poured into the mold to ensure that the material fills every crevice in the mold and that air bubbles within the material are eliminated. The filler member 1 prevents any excess of the model forming material from entering into lingual space 3 of the tray 5.

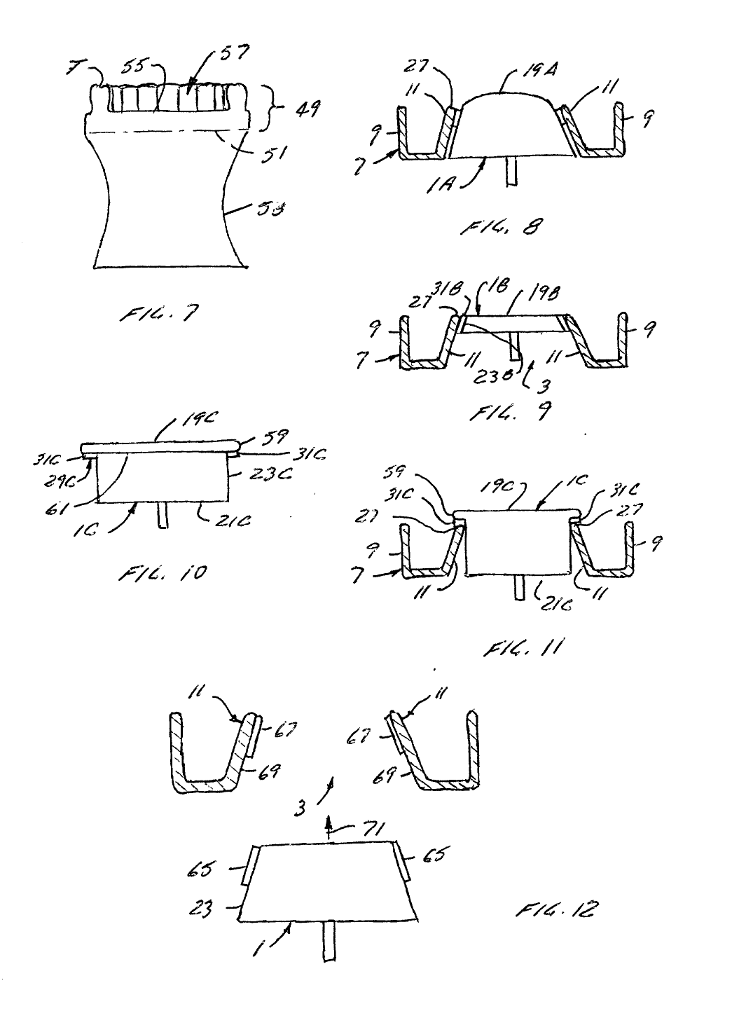

After the model-forming material 47 is poured into the mold 43, a base is also formed of the same model forming material and the filled mold is inverted and set, via its bottom 51, onto the base. When both the model and base have set, uniting the model to the base, the tray and filler member, via handling tab 35, are removed from the model. The hardened model 49, as shown in FIG. 7, sits inverted on the base 53 with the teeth T projecting upwardly. The upper surface 55 of the bottom 51 of the model 49, formed by the top surface 19 of the filler member 1, is smooth and flat.

Using the filler member 1 provides a neater and better looking dental model since the lingual space 53 in the model 51 is clearly defined and not filled with excess model forming material. The filler member 1 also forms the smooth and flat top surface 55. The use of the filler member 1 also reduces the chance of the mold distorting since the filler member can be quickly and easily installed allowing the model forming material to be poured immediately after the mold is formed and before the mold can begin to distort due to moisture imbalance. This results in more accurate models.

While the filler member 1 has been described as having a flat top 19, the filler member 1A can also have a top 19A, as shown in FIG. 8, that is convexly rounded in both the x and y directions of the member. The rounded top 19A extends above the top edge 27 of the inner wall 11 of the tray 5 and forms a bottom surface within the teeth of the finished model that is concave. The concave bottom surface provides better access into the lingual area when using the model.

While the filler member 1 is described as having a thickness equal to the height of the inner wall 11 of the tray 5, it could be made thinner, down to around a thickness of 0.50 cm. if desired. The filler member need only be thick enough to retain its shape during positioning and handling of both the member, and the tray carrying the member, and particularly only thick enough to prevent entry of the model forming material into lingual space. If a thinner filler member 1B is used, it is still shaped to fit in the upper part of the lingual space 3 of the tray with its top surface 19B substantially level with the top edge 27 of the inner wall 11 as shown in FIG. 9. An adhesive tape 31B on the side surface 23B of the member 1B holds it in position in the tray 5 to prevent access into the space 3 from the top. The thinner member 1B is shown with a flat top 19B but the top could also be rounded.

The filler member 1 has been shown as being attached to the outer surface of the inner wall of the tray which surface defines the lingual space 3. It could also be constructed to be fastened to the top edge 27 of the inner wall of the tray. As shown in FIG. 10, the filler member 1C has flat, top and bottom surfaces 19C, 21C joined by a curved sidewall 23C and a straight back wall (not shown). In this embodiment, the sidewall 23C does not slope or slant from the bottom surface 19C to the top surface 21C but rather is transverse to the top and bottom surfaces. A thin flange 59 extends laterally from the top portion of the member 1C, the top of the flange forming an extension of the top surface 21C. The flange 59 is sized to overlie the upper edge 27 of the inner wall 11 of the tray 5 as shown in FIG. 11. Connecting means 29C in the form of an adhesive tape 31C can be applied on the bottom surface 61 of the flange to contact the top edge 27 of the inner wall 11 when the member 1C is positioned within the lingual space in the tray, from the top of the space. The member 1C could have a flat top, as shown, or a rounded top. It could also be as thick as the height of the inner wall, or thinner as shown. The flanged member uses the flange 59 to prevent any model forming material from entering any gap between the inner wall 11 and the member.

While the connecting means 29 has been shown as adhesive on all embodiments of the filler member 1, the connecting means 29 could comprise cooperating connecting means on both the filler member 1 and the tray 5. These connecting means could, by way of example, be in the form of hook and eye patches of material with one set of the patches 65, the hook patches for example, adhered on the side surface 23 of the member and the other set of patches 67, the eye patches, adhered on the outer surface 69 of the inner wall 11 of the tray 5. The hook and eye patches 65, 67 adhere to each other when the filler member 1 is placed, as shown by directional arrow 71, in position within the lingual space 3 in the tray. Other forms of cooperating connecting means on both the member and tray can also be used.

The filler member can be made in various standard sizes to fit the lingual space on trays of various standard size. The filler member can be disposed of after use or it can be reused, with a new adhesive tape. A filler member with connecting means comprising hook and eye patches or similar cooperating, connecting means is meant to be reusable.

I claim:

1. A filler member for use in molding a dental model in a dental impression formed in a mold carried in a mandibular dental impression tray, the tray having a u-shaped trough formed by inner and outer u-shaped walls joined by a bottom wall and the inner wall defining a lingual space, the filler member being made from shape-retaining material with a smooth surface and shaped to fill at least the upper portion of the lingual space in the impression tray when placed therein in a manner to prevent model forming material, used in molding the model, from entering the lingual space on the tray from the upper portion of the tray.

2. A filer member as claimed in claim 1 including connecting means at least on the filler member for use in securing the member to the tray to retain it in position in the lingual space.

3. A filler member as claimed in claim 2 wherein the connecting means comprises a double-sided adhesive tape on the member.

4. A filler member as claimed in claim 2 wherein the connecting means comprises first cooperating connecting means on the filler member cooperating with second cooperating connecting means on the inner wall of the tray

5. A filler member as claimed in claim 2 wherein the member has a flat top surface and a bottom surface, the top and bottom surfaces joined by a curved sidewall which slopes inwardly from the bottom surface to the top surface.

6. A filler member as claimed in claim 2 wherein the member has a convex top surface and a bottom surface, the top and bottom surfaces joined by a curved sidewall which slopes inwardly from the bottom surface to the top surface.

7. A filler member as claimed in claim 2 wherein the member has a top surface and a bottom surface, the top and bottom surfaces joined by a curved sidewall, and a flange extending laterally from the top portion of the member to overlie the top edge of the inner sidewall of the tray when mounted in the lingual space.

8. A filler member as claimed in claim 7 wherein the top surface is flat and the side wall extends transverse to the top surface.

9. A filler member as claimed in claim 7 wherein the bottom wall is flat and the top wall is convex, the side wall extending transverse to the bottom wall.

10. A filler member as claimed in claim 7 wherein the connecting means is located on the bottom of the flange to contact the top edge of the inner wall of the tray.

11. A filler member as claimed in claim 2 wherein the filler member has an integral handling element projecting therefrom.

12. A filler ember as claimed in claim 3 wherein the member has a flat top surface and a bottom surface, the top and bottom surfaces joined by a curved sidewall which slopes inwardly from the bottom surface to the top surface, the adhesive tape mounted on the sidewall.

13. A filler ember as claimed in claim 3 wherein the member has a convex top surface and a bottom surface, the top and bottom surfaces joined by a curved sidewall which slopes inwardly from the bottom surface to the top surface, the adhesive tape mounted on the sidewall.

14. A filler member as claimed in claim 3 wherein the member has a top surface and a bottom surface, the top and bottom surfaces joined by a curved sidewall, and a flange extending laterally from the top portion of the member to overlie the top edge of the inner sidewall of the tray when mounted in the lingual space, the adhesive tape mounted on the bottom of the flange.
